(19) United States
(12) Patent Application Publication
(10) Pub. No.: US 2025/0076064 A1
(43) Pub. Date: Mar. 6, 2025

(54) MONITORING SYSTEM

(71) Applicant: GM Global Technology Operations LLC, Detroit, MI (US)

(72) Inventors: Daniel Pinheiro Carlesimo, Rochester Hills, MI (US); Anthony Stadnyk, Rochester Hills, MI (US); Aditya Singh, Rochester Hills, MI (US)

(73) Assignee: GM Global Technology Operations LLC, Detroit, MI (US)

(21) Appl. No.: 18/459,155

(22) Filed: Aug. 31, 2023

(51) Int. Cl. G01C 21/34; B60L 58/10; G07C 5/00; G07C 5/12

(52) U.S. Cl. CPC G01C 21/3476; B60L 58/10; G01C 21/3469; G07C 5/008; G07C 5/12

(57) ABSTRACT

A monitoring system includes a vehicle processor stores battery capacity data of a battery of a vehicle and includes a navigation application configured to provide a location of the vehicle and a vehicle route. A user device includes a display and data processing hardware in communication with the display. The data processing hardware executes a monitoring application in communication with the vehicle processor and executes a weather application including predicted weather data. The data processing hardware is configured to receive the vehicle route and provide a notification on the display of the user device corresponding to an installation attribute of a service station along the vehicle route.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a monitoring system.

Vehicles typically utilize gas or charging stations during travel. In an example of an electric vehicle, the vehicle may monitor a battery capacity, but may not otherwise monitor external factors. Climate and weather conditions may present uncertainty for a driver when it is unknown whether potential charging stations are equipped with covering to shelter the driver from the weather conditions. Drivers or other users may be cautious to utilize a charging station during inclement weather, such as rain or snow, if it is unknown whether the charging station has a covering to protect the driver from the inclement weather during charging.

It is also common for vehicles to include a navigation system to provide integrated directions for the driver. Most conventional navigation systems present turn-by-turn directions and may offer new routes during navigation to save time for the driver. However, conventional navigation systems rarely present context-sensitive information about charging station attributes. Thus, the driver typically has to separately identify a convenience station with attributes that may provide coverage for the driver during charging and input a new destination to the navigation system to be directed to a nearby station.

### SUMMARY

In some configurations, a vehicle monitoring system includes a vehicle processor that stores battery capacity data of a battery of a vehicle and includes a navigation application configured to provide a location and a route of the vehicle. A server includes a server processor that is communicatively coupled with the vehicle processor and stores a service route database and installation attributes of one or more service stations stored in the service route database. The server processor also includes a weather application configured to predict service station weather based on predicted weather data and the service route database. A user device includes a display and data processing hardware in communication with the display and executes a monitoring application in communication with the server processor. The server is configured to receive the route of the vehicle and provide a notification on the display of the user device corresponding to one or more of the installation attributes of one or more of the service stations stored in the service route database.

In some examples, the user device may include at least one of a mobile device and an infotainment device of the vehicle. In other aspects, the monitoring application may be configured to recommend a service stop based on the predicted weather data received from the server processor and the battery capacity data received from the vehicle processor. The server processor may be configured to send a notification to the monitoring application in response to the predicted weather data. The notification may include a preparation protocol. The preparation protocol may include at least one of a charging recommendation, accessory recommendations, and preparation recommendations. In some examples, the server processor may be configured to receive an installation update from a third party device corresponding to the installation attribute of one of the service stations stored in the service route database. Optionally, the monitoring application may be configured to display an alternate route based on the predicted weather data relative to the route of the vehicle.

In another aspect, a monitoring system for a vehicle includes a vehicle processor that stores battery capacity data of a battery of the vehicle and includes a navigation application configured to provide a location and a route of the vehicle. A server processor is communicatively coupled with the vehicle processor and stores a service route database and installation attributes of one or more service stations stored in the service route database. The monitoring system also includes a user device that includes a display and data processing hardware in communication with the display. The data processing hardware executes a monitoring application in communication with the server processor. The server processor is configured to receive the route of the vehicle and provide a notification on the display of the user device corresponding to one or more of the installation attributes of the one or more service stations stored in the service route database.

In some aspects, the server processor may further include a weather application communicatively coupled with the service route database and configured to provide weather data for the one or more service stations stored in the service route database. The installation attributes may include a shelter installation proximate to a charging station of the one or more service stations. The monitoring application of the user device may be configured to provide a route notification on the display including a reroute selection corresponding to a service station that may include the shelter installation. The monitoring application may be configured to receive the route notification from the server, and the server processor may be configured to compare the service route database and the installation attributes with the weather data to generate the route notification. Optionally, the monitoring application may be configured to display predicted weather corresponding to a location of a service station along the route of the vehicle. In some examples, the data processing hardware of the user device may be communicatively coupled to the vehicle processor to receive the battery capacity data and configured to display the battery capacity data on the display of the user device.

In yet another aspect, a monitoring system includes a vehicle processor that stores battery capacity data of a battery of a vehicle and includes a navigation application configured to provide a location of the vehicle and a vehicle route. A user device includes a display and data processing hardware in communication with the display. The data processing hardware executes a monitoring application in communication with the vehicle processor and executes a weather application including predicted weather data. The data processing hardware is configured to receive the vehicle route and provide a notification on the display of the user device corresponding to an installation attribute of a service station along the vehicle route.

In some examples, the monitoring system may include a server that may include a server processor communicatively coupled with the vehicle processor and stores a service route database and installation attributes of one or more service stations stored in the service route database. The service route database may include an availability status of a charging station at one of the service stations. The server processor may be configured to identify a service station from the service route database that includes an installation attribute and may be configured to determine whether there is sufficient battery capacity of the vehicle to reroute the vehicle route based on the battery capacity data and the weather data. The vehicle processor may be configured to execute the vehicle route in response to a user input to the navigation application and based on the installation attributes stored in the service route database. Optionally, the monitoring application may be configured to issue a route notification corresponding to an updated route based on the predicted weather data and the vehicle route.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle having a vehicle processor in communication with a user device according to the present disclosure:

FIG. 2 is a schematic diagram of a monitoring system according to the present disclosure:

FIG. 3 is a functional block diagram of a monitoring system according to the present disclosure, the monitoring system including a server, a vehicle processor, and a user device in communication with service stations:

FIG. 4 is a schematic view of a user device with a monitoring application according to the present disclosure:

FIG. 5 is a schematic view of an energy assist feature of a monitoring application displayed on a user device according to the present disclosure:

FIG. 6 is a schematic view of a route planning feature of the monitoring application of FIG. 5 displayed on the user device:

FIG. 7 is a functional block diagram of a monitoring system according to the present disclosure:

FIG. 8 is a schematic view of a user device with navigation graphics of a monitoring application according to the present disclosure:

FIG. 9A is a schematic view of a user input selecting a service station weather icon of a monitoring application according to the present disclosure displayed on a user device:

FIG. 9B is a schematic view of predicted service station weather displayed on the user device of FIG. 9A:

FIG. 10 is a schematic view of a user device with a shelter icon for a service station recommendation of a monitoring application according to the present disclosure;

FIG. 11A is a schematic view of a user device with a weather notification from a monitoring application according to the present disclosure:

FIG. 11B is a schematic view of a preparation protocol of the monitoring application of FIG. 11A displayed on the user device; and

FIG. 12 is an example flow diagram of a monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises.” “comprising.” “including.” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term module may be replaced with the term circuit. The term module may refer to, be part of, or include an Application Specific Integrated Circuit (ASIC): a digital, analog, or mixed analog/digital discrete circuit: a digital, analog, or mixed analog/digital integrated circuit: a combinational logic circuit; a field programmable gate array (FPGA): a processor (shared, dedicated, or group) that executes code; memory (shared, dedicated, or group) that stores code executed by a processor: other suitable hardware components that provide the described functionality: or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry. e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

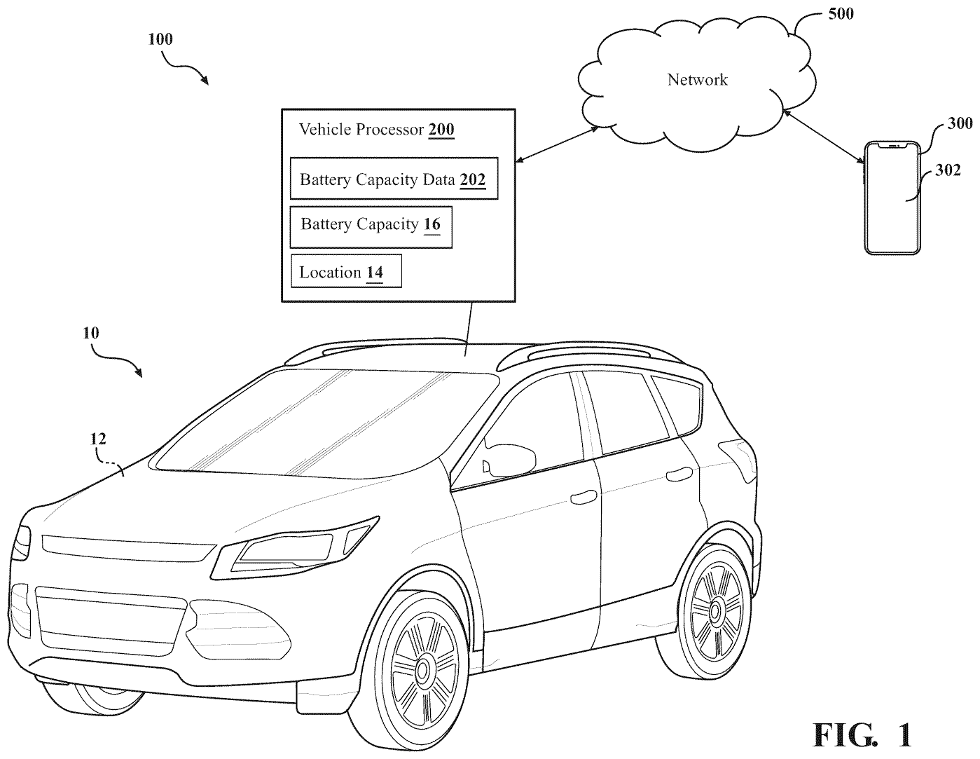

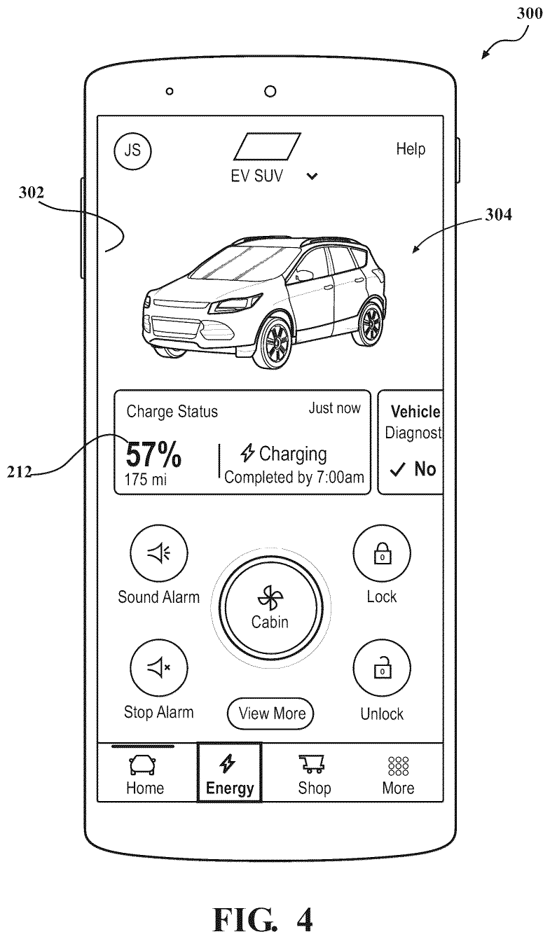

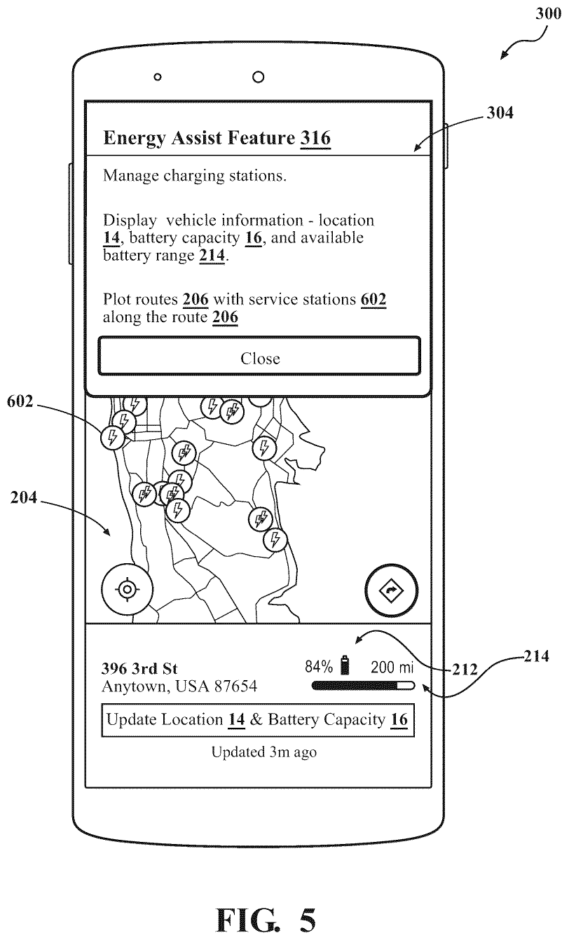

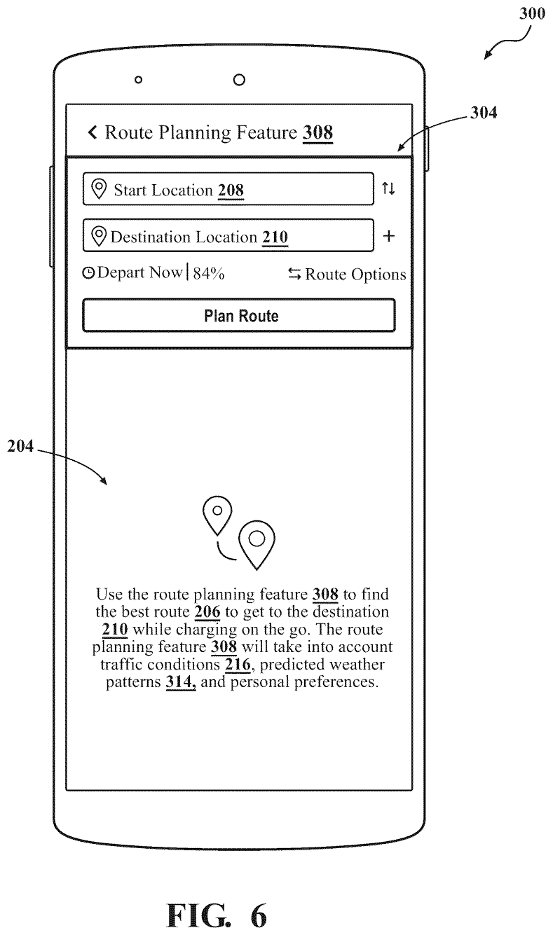

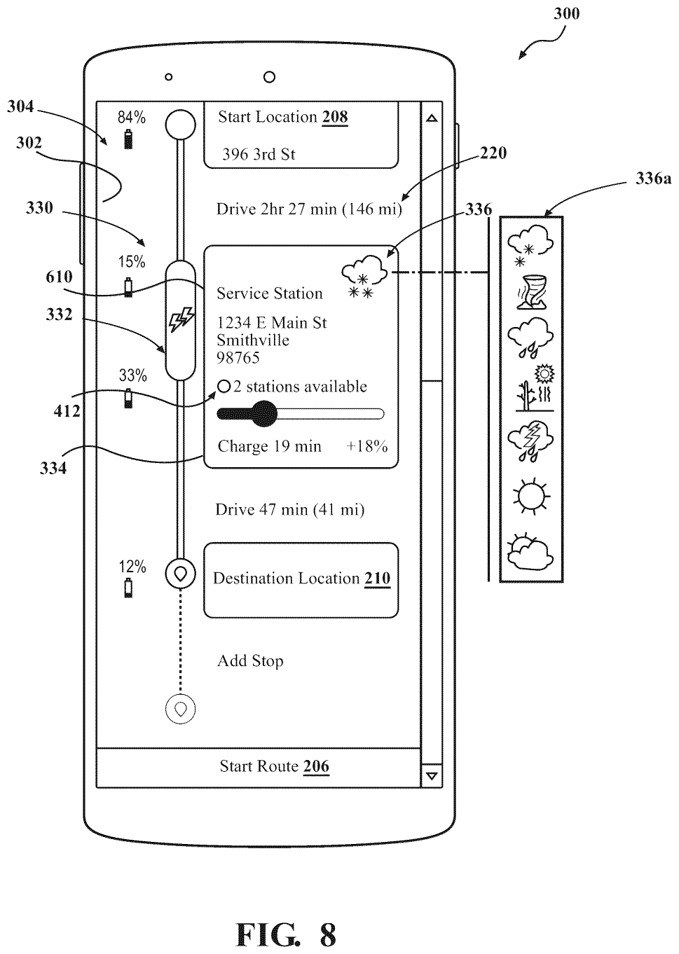

Referring to FIGS. 1-12, a monitoring system 100 for a vehicle 10 includes a vehicle processor 200 of the vehicle 10 in communication with a user device 300. The vehicle 10, described below, is contemplated to be an electric vehicle (EV) with autonomous or semi-autonomous capabilities. Additionally or alternatively, the vehicle 10 may be a hybrid vehicle incorporating both EV and internal combustion engine (ICE) components and capabilities. Accordingly, the vehicle 10 is equipped with a battery 12 to provide, at least in part, propulsion assistance of the vehicle 10. The vehicle processor 200 stores battery capacity data 202 of the battery 12 of the vehicle 10 and may communicate the battery capacity data 202 with the user device 300.

The monitoring system 100 may also include a server 400 that is communicatively coupled with one or both of the vehicle processor 200 and the user device 300. As described herein, the monitoring system 100 collectively describes one or more of the vehicle processor 200, the user device 300, and the server 400. The server 400 may be configured as a back office system for the monitoring system 100, which may determine, recommend, and/or execute operations of the monitoring system 100 in combination with the vehicle processor 200 and the user device 300. For example, the user device 300 may include an application programming interface (API) in communication with a weather server to obtain the weather data, described below; in order to minimize a load on the server 400. Each of the vehicle processor 200, the user device 300, and the server 400 may be in communication via a network 500, which provides wireless communication for the monitoring system 100. The network 500 also provides wireless communication between the monitoring system 100 and a third party device 600, which may correspond to one or more service stations 602. For example, a service station 602 may provide information via the third party device 600 to the monitoring system 100 corresponding to installation attributes 604 associated with the respective service stations 602, described in more detail below:

With reference now to FIGS. 1-3, the vehicle processor 200 includes a navigation application 204 in addition to storing the battery capacity data 202, mentioned above. The navigation application 204 may be utilized to identify and monitor a location 14 of the vehicle 10 and is communicatively coupled with the user device 300 to share the location 14 with an occupant of the vehicle 10 and/or a user of the user device 300. The vehicle processor 200 is configured to provide the battery capacity data 202 to the user device 300, such that the user device 300 may display the battery capacity data 202 on a display 302 of the user device 300. The vehicle processor 200 stores and regularly updates the battery capacity data 202 through monitoring of the battery 12 and may reference the navigation application 204 to compare the location 14 of the vehicle 10 with the battery capacity data 202. Thus, an occupant of the vehicle 10 may monitor a battery capacity 16 of the battery 12, along with the location 14 of the vehicle 10, which may inform a route 206 of the vehicle 10. The navigation application 204 is configured to generate the route 206 of the vehicle 10 in addition to monitoring the location 14 of the vehicle 10.

In some aspects, the route 206 may be input through the user device 300, such that either of the vehicle processor 200 or the user device 300 may be configured with the navigation application 204. In some examples, the user device 300 may be an infotainment device 300a incorporated with the vehicle 10. Accordingly, the vehicle processor 200 may be configured with the navigation application 204 and may present the navigation application 204 on the infotainment device 300a for manipulation by the user or occupant. In either configuration, the user may input a start location 208 and a destination location 210 to determine the route 206. In some examples, the user may input the destination location 210, and the vehicle processor 200 automatically sets the start location 208 based on the location 14 of the vehicle 10.

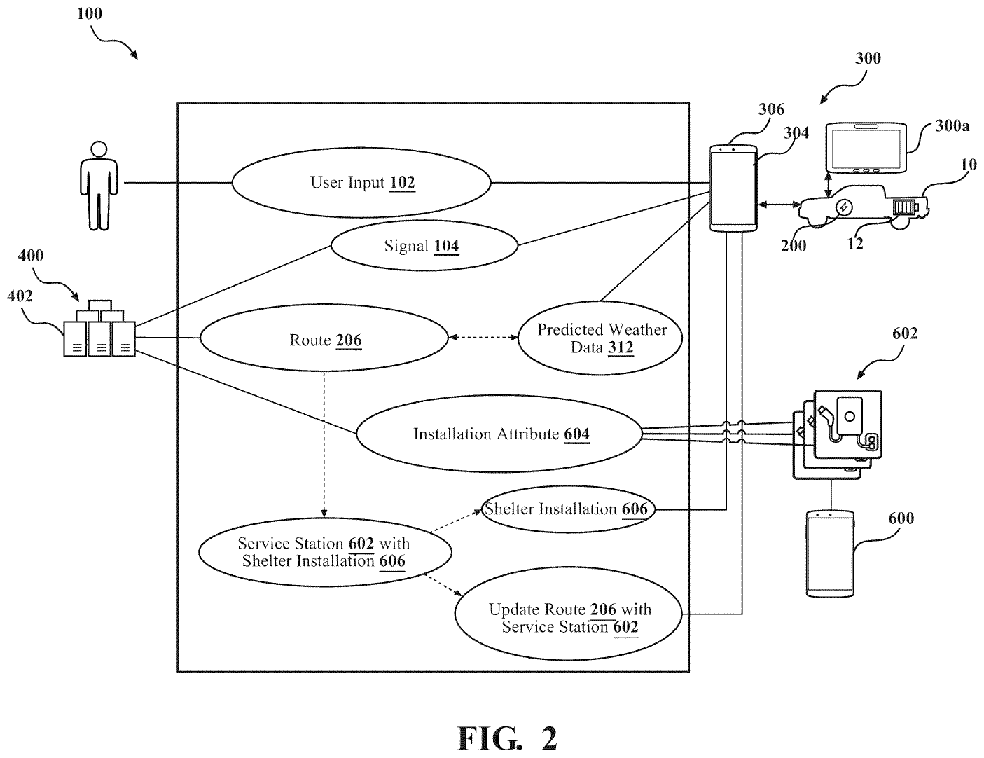

With further reference to FIGS. 1-3 and as described further below, the monitoring system 100 is configured to monitor the vehicle 10 using the navigation application 204 as the vehicle 10 travels along the route 206. The monitoring system 100 is configured to identify service stations 602 located along the route 206, which may include differentiating between nearby service stations 602 and service stations 602 that may be located a further distance from the route 206. While each aspect of the monitoring system 100 is described in detail below; FIG. 2 depicts an overview of the monitoring system 100. For example, the user may provide a user input 102 to a monitoring application 304 stored on data processing hardware 306 of the user device 300. The monitoring application 304 is configured with a route planning feature 308 that may be selected by the user. The route planning feature 308 may operate in conjunction with or separate from the navigation application 204. For example, the route planning feature 308 may be utilized to execute the route 206 by providing adjustments and/or recommendations in response to the monitoring application 304 receiving data from a weather application 310 and the server 400, as described below.

Referring to FIG. 2, the server 400 may receive a signal 104 corresponding to the user input 102 to provide one or both of the vehicle processor 200 and the monitoring application 304 with a route 206. The route 206 may be generated by the navigation application 204 on the vehicle processor 200 prior to the server 400 receiving the signal 104. For example, the route 206 may be provided to the server 400, and the server 400 may update the route 206 to include identified service stations 602 along the route 206. It is also contemplated that the server 400 may independently generate the route 206 and include the identified service stations 602.

With reference still to FIGS. 1-3, the monitoring application 304 is in communication with the weather application 310, which may be stored on the data processing hardware 306 of the user device 300. Alternatively, the weather application 310 may be stored on a server processor 402 of the server 400. In either configuration, the monitoring application 304 is in communication with the weather application 310 to further update the route 206 based on predicted weather data 312. The predicted weather data 312 may include a predicted weather pattern 314 along the route 206 and/or at one or more of the service stations 602 along the route 206. The predicted weather pattern 314 may inform the identified service stations 602 by the monitoring system 100. For example, the server processor 402 includes a service route database 404 and may be configured to identify a service station 602 from the service route database 404 that includes an installation attribute 604 from the service route database 404. The installation attribute 604 may provide advantageous protection from the predicted weather pattern 314. The server processor 402 may determine whether the battery 12 of the vehicle 10 has sufficient battery capacity 16 to reroute the route 206 based on the battery capacity data 202 and the predicted weather data 312.

The server 400 may communicate with the monitoring application 304 the potential installation attributes 604 of the service stations 602 along the route 206, which may be advantageous based on the predicted weather data 312. The server 400 may recommend service stations 602 based on the installation attributes 604 and, specifically, if one of the installation attributes 604 includes a shelter installation 606. Thus, the route 206 may be adjusted and updated by the monitoring system 100 in real-time during travel of the vehicle 10. Each of the above features and operations is described in further detail herein.

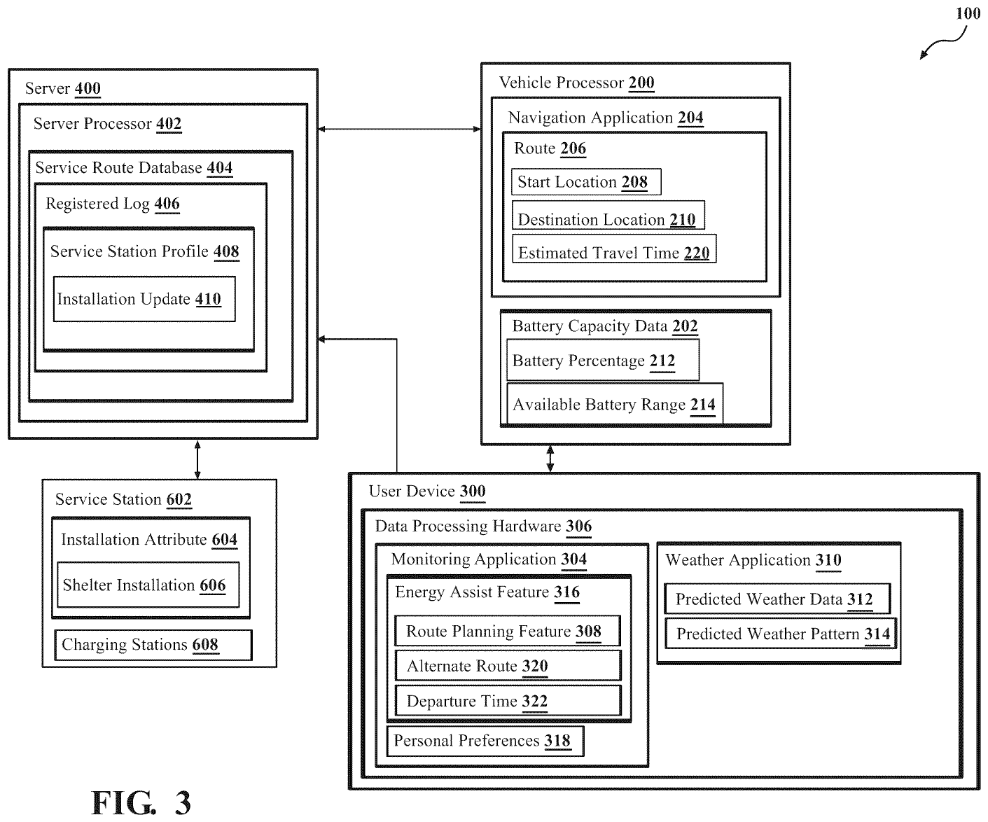

Referring now to FIGS. 3-6, the user device 300 is depicted as a mobile device configured to wirelessly communicate with the vehicle processor 200. As mentioned above, in some examples, the user device 300 may be an infotainment device 300a of the vehicle 10, such that the occupant may interact with the user device 300 via an integrated display 302 of the vehicle 10 that may display information pertaining to the vehicle 10 in addition to entertainment data. The user device 300 includes the data processing hardware 306, which is in communication with the display 302. The data processing hardware 306 includes the monitoring application 304 and is also in communication with the vehicle processor 200 to receive the battery capacity data 202 and the route 206 from the vehicle processor 200. The data processing hardware 306 presents each of the battery capacity data 202 and the route 206 on the display 302 as part of the monitoring application 304. As mentioned above, the route 206 may be generated by any combination of the navigation application 204, the server 400, and the user device 300. For example, the data processing hardware 306 may receive the route 206 from the vehicle processor 200, and the route 206 may be updated or otherwise modified by one or both of the server 400 and the monitoring application 304.

With further reference to FIGS. 3-6, the server 400 is in communication with the data processing hardware 306 and the vehicle processor 200 to exchange information related to the vehicle 10 and conditions pertaining to and along the route 206. The server processor 402 stores the service route database 404, which includes a registered log 406 of service stations 602 within a geographic region along the route 206. The server processor 402 may also store the installation attributes 604 of the respective service stations 602 on the service route database 404. The service route database 404 may receive updated data from the service stations 602 located along or near the route 206 pertaining to potential installation attributes 604. For example, each service station 602 may update a service station profile 408 on the registered log 406 with newly added or modified installation attributes 604 via an installation update 410. In some examples, the installation attributes 604 may include the shelter installation 606, which covers a charging station 608 at the service station 602.

It is contemplated that the service station profile 408 may be updated by personnel of the service station 602. Third party users of the respective service station 602 may flag or otherwise alert the server 400 to a potential discrepancy regarding the installation attributes 604. In either example, the server 400 may receive the installation update 410 from the third party device 600 (FIG. 2) corresponding to a newly installed or updated installation attribute 604 that may provide shelter or coverage over the charging station 608 in the event of inclement weather. As noted above, the weather application 310 may present the predicted weather data 312 along the route 206, which may correspond with locations along the route 206 and/or may correspond to one or more of the service stations 602 along and near the route 206. The presented weather data 312 is configured to account for a time of arrival, such that the predicted weather data 312 corresponds to the time of day when the vehicle 10 is predicted to arrive at the service station 602. Presenting the predicted weather data 312 associated with the time of arrival of the vehicle 10 may advantageously assist the user in planning travel in an effort to anticipate the weather at planned stops. In some examples, the weather application 310 may be stored on the server 400, such that the weather application 310 may be configured to determine the predicted weather data 312 in combination with providing the service station 602 information. The server 400 may also update the route 206 based on the predicted weather data 312. Regardless of whether the weather application 310 is stored on the server processor 402 or the data processing hardware 306, the predicted weather data 312 may be utilized to provide additional context along the route 206.

With continued reference to FIGS. 3-6, the monitoring system 100 collectively utilizes the navigation application 204, the weather application 310, and the service route database 404 to provide data from each to the occupant. The monitoring system 100 utilizes the monitoring application 304 as the user facing portion of the monitoring system 100 that assists the user in monitoring the vehicle 10 and information affecting the vehicle 10 before and during travel along the route 206. For example, the monitoring application 304 assists in monitoring the route 206, the predicted weather data 312 both along the route 206 and at the respective service stations 602, the weather data 312 at particular times of day including a predicted time of arrival at the respective service stations 602, and the installation attributes 604 of each respective service station 602, among other monitoring features. As noted above, each of the vehicle processor 200, the data processing hardware 306, and the server processor 402 are communicatively coupled via the network 500 (FIG. 1) to collectively define the monitoring system 100. The data gathered and analyzed by each of the vehicle processor 200 and the server processor 402 is ultimately presented to the occupant on the display 302 of the user device 300 after being incorporated into the monitoring application 304 by the data processing hardware 306.

For example, the data processing hardware 306 may present the battery capacity data 202 in the monitoring application 304 as a battery percentage 212. It is also contemplated that the battery capacity data 202 may be configured and presented as an available battery range 214. In some examples, both the battery percentage 212 and the available battery range 214 may be presented on the monitoring application 304. The monitoring application 304 is configured to present the battery capacity data 202 and data associated with the service station 602 to advantageously assist the user in monitoring a status of the battery capacity 16 of the vehicle 10, while also monitoring the available service stations 602 along the route 206.

With further reference to FIGS. 3-6, the route planning feature 308 of the monitoring application 304 may be part of an energy assist feature 316. For example, the occupant may input the destination location 210 in the route planning feature 308 of the monitoring application 304, and the navigation application 204 may generate the route 206 in response.

Accordingly, the route planning feature 308 may be communicatively coupled with the navigation application 204. The route planning feature 308 may be utilized to determine an energy route 320) that corresponds to an alternate route 320 configured to maximize the energy efficiency of the vehicle 10. In some examples, the energy assist feature 316 may utilize the predicted weather data 312 and personal preferences 318 of the user to generate the energy or alternate route 320. It is contemplated that the monitoring application 304 may present the route 206 generated by the navigation application 204 to the user and may also present the energy route 320 generated by the route planning feature 308. The energy route 320 may be generated by the energy assist feature 316 to maximize the available battery range 214 by avoiding events that may reduce the available battery range 214 at an accelerated rate.

In some examples, elevated and/or reduced ambient temperatures may reduce the available battery range 214 at a rate that is faster than at a reduced ambient temperature. For example, the user may utilize cooling features of the vehicle 10, which may create a heavier battery load during the peak ambient temperatures. Comparatively, the reduced ambient temperatures associated with extreme cold may reduce the available battery range 214 as a result of the ambient temperature. Thus, the route planning feature 308, in combination with the energy assist feature 316, may recommend that a departure time 322 be set to avoid traveling during times associated with peak and/or reduced ambient temperatures. The route planning feature 308 and the energy assist feature 316 are configured to be routinely updated by the data processing hardware 306 during navigation of the vehicle 10.

Referring still to FIGS. 3-6, the energy assist feature 316 may also utilize the predicted weather data 312, the route 206, and the service route database 404. It is generally contemplated that, while the energy assist feature 316 may present an energy route 320 that optimizes energy efficiency, the energy route 320 has minimal deviation from a direct route 206 that may otherwise be presented by the navigation application 204. For example, the monitoring application 304 may compare the energy route 320 determined by the energy assist feature 316 with the route 206 determined by the navigation application 204. If, in this example, the energy route 320 deviates from the route 206 from the navigation application 204 to the extent that a travel time exceeds a preset threshold, then the monitoring application 304 may recommend the vehicle 10 travel along the route 206 generated by the navigation application 204.

It is contemplated that the monitoring application 304 may still present the energy route 320 from the energy assist feature 316, but the monitoring application 304 may present an alert indicating that the energy route 320 may add additional time to the overall travel time. In some examples, however, the energy route 320 may have a minor increase or no change in the travel time. In this example, the monitoring application 304 may present the energy route 320 as the primary route 320 option, while presenting the route 206 from the navigation application 204 as a secondary route option. Regardless of which route 206, 320 is selected by the user, the monitoring application 304 may highlight service stations 602 along the route 206, 320 to assist the user in efficiently navigating to a service station 602.

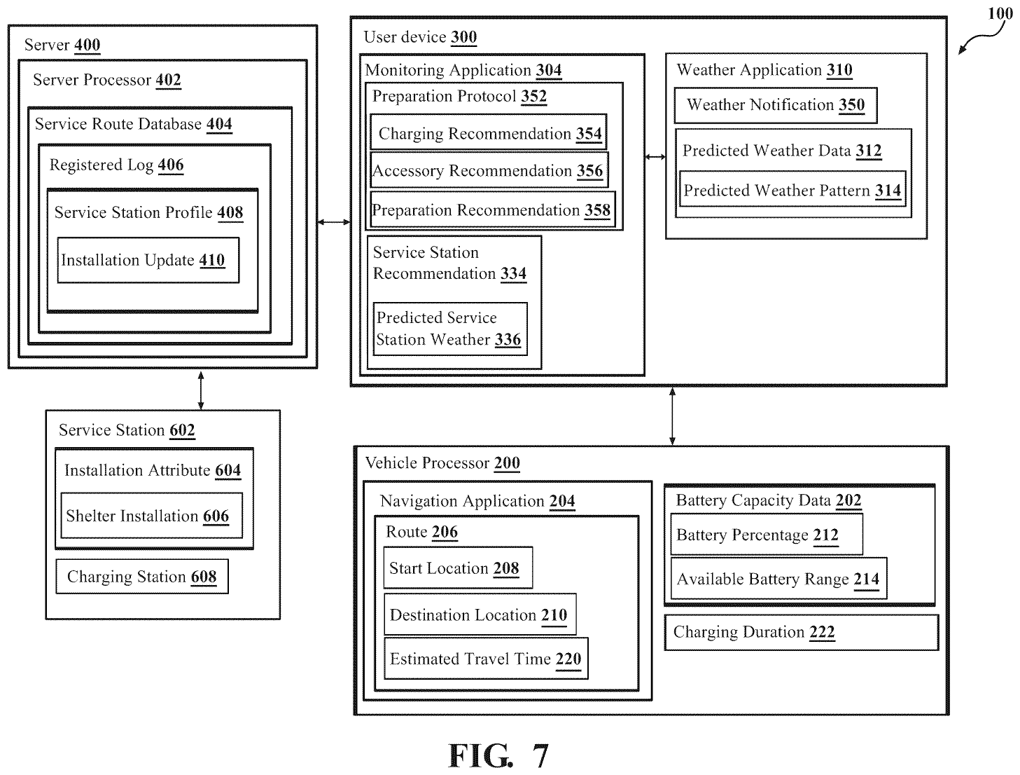

Referring now to FIGS. 7-10, the monitoring system 100 presents, via the monitoring application 304, step-by-step navigation graphics 330 for the route 206. In some aspects, the monitoring application 304 presents, at the start location 208, an estimated travel time 220 and projects one or more service stops 332, integrated as part of the route 206, with one or more service station recommendations 334. The service station recommendations 334 may present data about the recommended service station(s) 602 obtained by the monitoring application 304 from the service route database 404 stored on the server processor 402. It is contemplated that the monitoring application 304 may configure the service station recommendations 334 based on the service station profiles 408 stored on the service route database 404, including the installation attributes 604 for the respective service station 602. For example, the server processor 402 may select one or more of the service station profiles 408 and may communicate the selected service station profile 408 to the monitoring application 304 to, ultimately, be presented as part of the navigation graphics 330 on the monitoring application 304.

The monitoring application 304 may receive the respective service station profile 408 from the server processor 402, which may include identification information of the service station 602. The identification information may include, but is not limited to, a name and the location 610 of the service station 602. The location 610 of the service stations 602 may be displayed as part of the route 206 generated by the navigation application 204. Each location 610 of the service stations 602, in combination with the route 206, may be presented on the display 302 of the user device 300. The service station profile 408 may also include an availability status 412 of the charging stations 608. For example, the monitoring application 304 may adjust which service station 602 is selected for the service stop 332 based on the availability status 412 of the charging stations 608. The monitoring application 304 may also evaluate the battery capacity data 202 to predict a charging duration 222 and a projected battery percentage 212. It is generally contemplated that the service stop 332 may be presented on the monitoring application 304 as a range to facilitate flexibility during navigation of the route 206.

In some aspects, the monitoring application 304 may update with a new service station profile 408 from the service route database 404 as the vehicle 10 travels along the route 206. The monitoring application 304 may present multiple service station profiles 408, which may be selected by the user via the user input 102. The user may also dismiss the recommended service station profiles 408 via the user input 102. In either example, the monitoring application 304 may present an alert to the user when the available battery range 214 is approaching a distance to the next available service station 602.

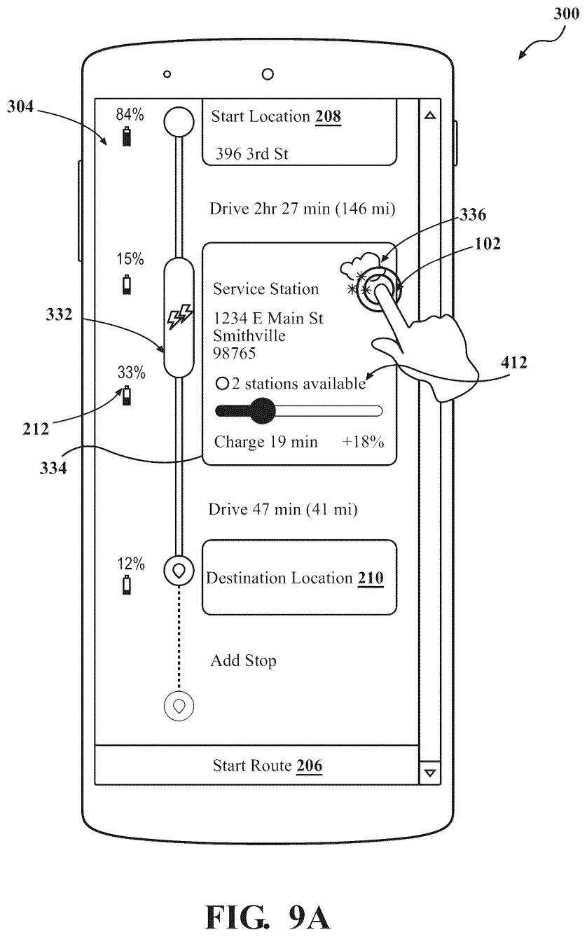

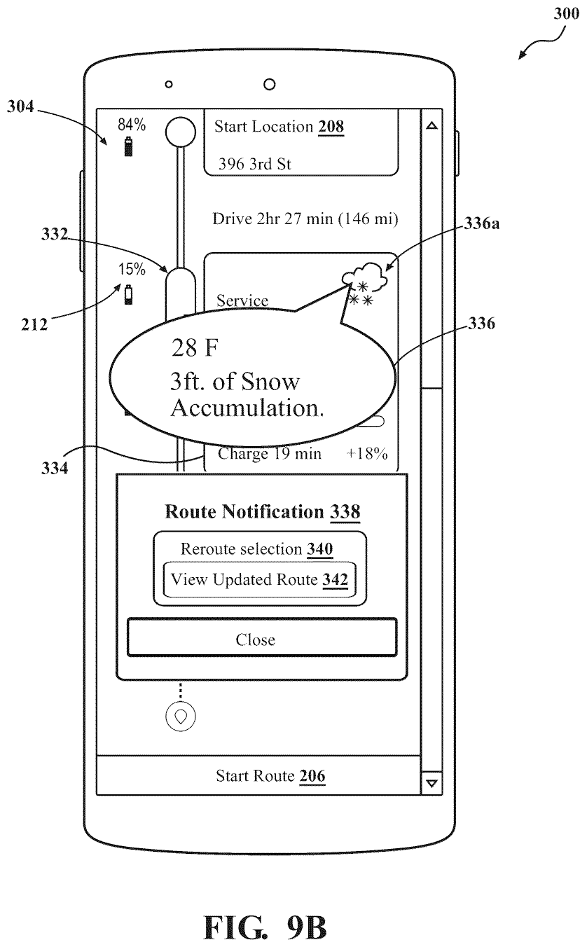

With further reference to FIGS. 7-10, the monitoring application 304 advantageously utilizes the weather application 310 to present predicted service station weather 336. For example, the monitoring application 304 is configured to display the predicated service station weather 336 on the display 302 of the user device 300 at the predicted time of arrival. The predicted service station weather 336 may be presented on the monitoring application 304 as part of the service station profile 408. For example, the weather application 310 may communicate with the server processor 402 to update the service station profile 408 at regular intervals to present the predicted service station weather 336. The predicted service station weather 336 may be presented on the display 302 as a weather icon 336a generally corresponding to the predicted service station weather 336. As illustrated in FIGS. 9A and 9B, the weather icon 336a illustrates a cloud with snowflakes that when selected via the user input 102, presents a description of the predicted service station weather 336. Although the weather icon 336a is illustrated in FIG. 9B as a cloud with snowflakes, it is contemplated that the weather icon 336a may include, but is not limited to, clouds, rain, snow, sleet, tornados, hail, wind, sun, storms, and any other graphic of weather patterns. The monitoring application 304 communicates with the weather application 310 to regularly update the predicted service station weather 336 throughout operation of the monitoring application 304.

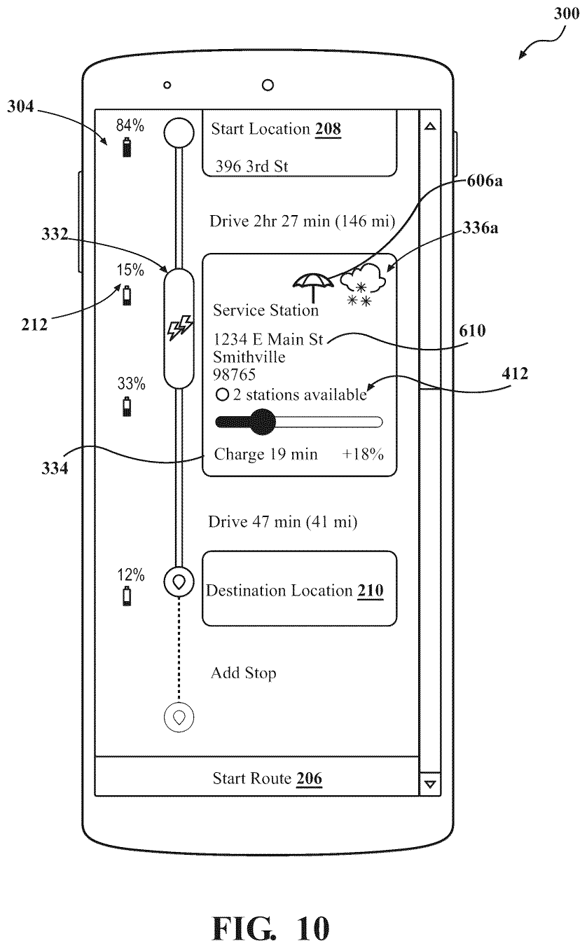

The monitoring application 304 further provides installation attributes 604 that may be present at the recommended service station 602. As mentioned above, the installation attributes 604 may include the shelter installation 606. The shelter installation 606 may also be presented as a shelter icon 606a on the monitoring application 304 as part of the service station profile 408. For example, the shelter icon 606a is depicted in FIG. 10 as an umbrella. However, other icons 606a may be used to convey that the recommended service station 602 is equipped with at least one shelter installation 606 at the charging station 608. The shelter installation 606 may be a garage, canopy, overhang, or any other practicable shelter or covering that is adjacent to or sheltering the charging station 608. The monitoring application 304 may prioritize the service stations 602 that include an installation attribute 604, and in particular a shelter installation 606, in response to the predicted service station weather 336. In some aspects, the monitoring application 304 may present a route notification 338 on the display 302 that includes a reroute selection 340, which reroutes the previously selected route 206 to utilize the service station 602 that includes the shelter installation 606.

Referring still to FIGS. 7-10, the monitoring application 304 may selectively present the shelter icon 606a representing the shelter installation 606. For example, if the monitoring application 304 determines that the predicted service station weather 336 is not inclement or otherwise free from weather events that may affect the user during a charging event, then the service station recommendation 334 may be free of the shelter icon 606a. For example, if the predicted service station weather 336 is fair and free from precipitation, then the monitoring application 304 may present the service station recommendation 334 without the shelter icon 606a, even where a shelter installation is present. In other examples, if the monitoring application 304 determines that the predicted service station weather 336 may present an inconvenience to the user, then the monitoring application 304 may display the shelter icon 606a indicating that the recommended service station 602 has a shelter installation 606. While the recommended service station 602 may remain unchanged during periods of predicted service station weather 336 that may warrant the use of a shelter installation 606, it is also contemplated that the monitoring application 304 may recommend an updated route 342 in the event of the predicted service station weather 336 including inclement weather.

In some examples, the monitoring application 304 may receive a signal from the weather application 310 indicating that the predicted weather data 312 is projecting inclement weather along the route 206. Thus, the monitoring application 304 may issue an alert to the user indicating the potential for inclement weather, based on the predicted weather data 312, and may recommend the updated route 342 in an effort to avoid the potential inclement weather. If the predicted weather data 312 is an inconvenient weather event, such as rain or snow; but not inclement, the monitoring application 304 may present the shelter icon 606a for the recommended service station 602 indicating that the recommended service station 602 is equipped with a shelter installation 606.

In some aspects, the route notification 338 may correspond to the updated route 342 based on the predicted weather data 312, where the predicted weather data 312 corresponds to a predicted weather pattern 314 along the route 206. The monitoring application 304 receives the predicted weather data 312 from the weather application 310 and may determine that a predicted weather pattern 314 may impede travel along the previously selected route 206. In addition to presenting an alert with the predicted weather data 312, the monitoring application 304 may present the route notification 338 proposing the updated route 342. In some aspects, the monitoring application 304 may automatically proceed with the updated route 342 and provide the route notification 338 to the user of the automatic rerouting of the vehicle 10 to proceed on the updated route 342 in response to a severity of the predicted weather pattern 314.

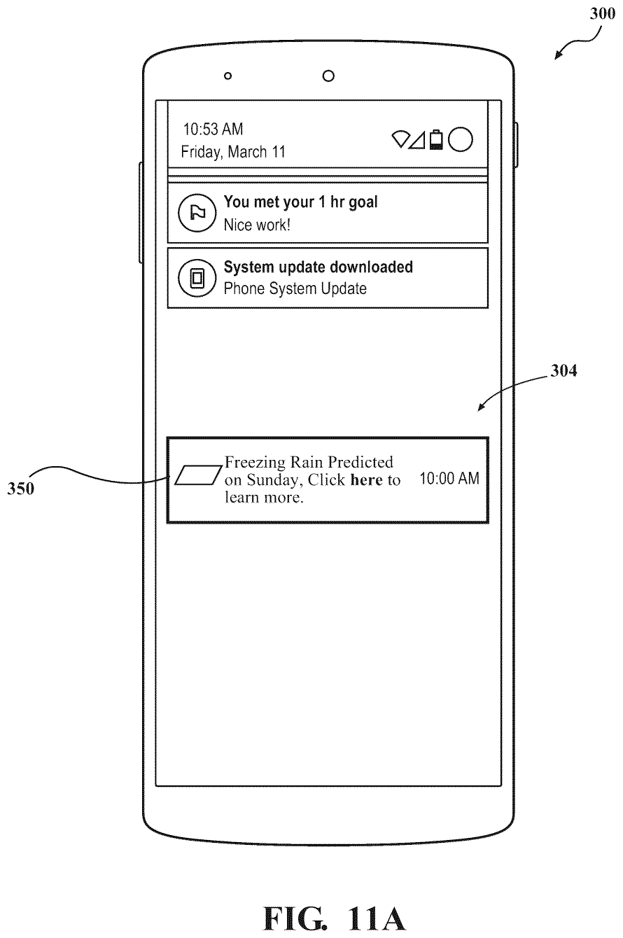

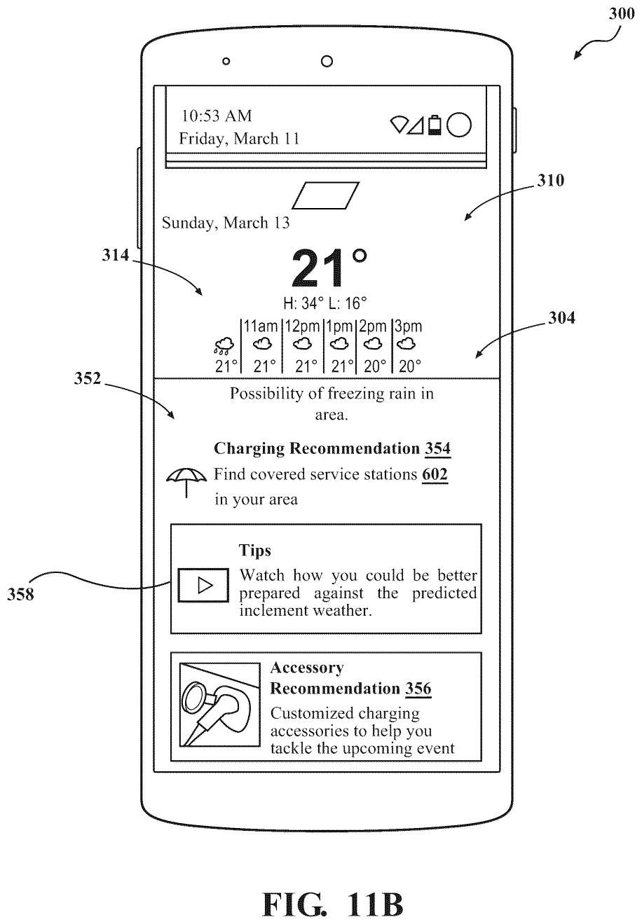

Referring now to FIGS. 7, 11A, and 11B, the monitoring application 304 is also configured to issue a weather notification 350 based on the predicted weather data 312, separate from operation of the vehicle 10, in the event that a user has input an exposed setting for a private service station 602. The user may input into the monitoring application 304 an installation attribute 604 of the private service station 602. For example, the user may input that the private service station 602 includes a covered installation attribute 604, in which case the monitoring application 304 may refrain from issuing the weather notification 350. In other examples, the private service station 602 may be set to an exposed status or, as a default, an unknown status.

In the instance of the exposed status and/or the unknown status, the monitoring application will issue the weather notification 350 based on the predicted weather 312 and the shelter status of the private service station 602. For example, the weather notification 350 may include information pertaining to inclement weather and recommendations for actions that may be taken by the user in preparation for the inclement weather. The weather notification 350 may, for example, include a preparation protocol 352, which may present options for the user. The preparation protocol 352 includes, but is not limited to, a charging recommendation 354, accessory recommendations 356, and preparation recommendations 358. It is contemplated that the user may select one or more of the recommendations 354, 356, 358 presented as part of the preparation protocol 352. Alternatively, the user may silence or dismiss the weather notification 350 and the preparation protocol 352.

The preparation protocol 352 is configured to advantageously assist a user in response to the predicted weather pattern 314 received from the weather application 310, which may otherwise impact the user. The charging recommendation 354 is configured to recommend that the user charge the battery 12 ensure the battery 12 is at full battery capacity 16 prior to the start of the predicted weather pattern 314. In some examples, the vehicle 10 may be utilized as a backup energy source for providing power to a home of the user, such that providing the preparation protocol 352, and recommending a full battery capacity 16 prior to the predicted weather pattern 314, is advantageous. Further, the accessory recommendations 356 of the preparation protocol 352 include recommendations for various accessories that may be utilized in combination with the vehicle 10. The accessory recommendations 356 may include links or other purchasing options to assist the user in obtaining an accessory that may be utilized in combination with the vehicle 10 prior to the predicted weather pattern 314.

With further reference to FIGS. 7, 11A, 11B, the preparation protocol 352 is configured to provide the accessory recommendations 356 ahead of the predicted weather pattern 314, such that a delivery time for the accessory is accounted for when presenting the accessory recommendations 356. For example, the monitoring application 304 may present the accessory recommendation 356 at least one to two days before the predicted weather pattern 314 to account for the delivery time of the recommended accessory. The accessory recommendations 356 may also provide nearby retailers that may carry the recommended accessory if the predicted weather pattern 314 is before the estimated delivery time. Accordingly, the monitoring application 304 may present various purchasing options for select, recommended accessories through the preparation protocol 352. In some examples, it is contemplated that the user may execute a purchase of the recommended accessories through the monitoring application 304 to streamline the efficiency and order process associated with the accessory recommendations 356.

The preparation recommendations 358 of the preparation protocol 352 may include context based suggestions that the user may evaluate in preparation for the potential inclement weather. For example, the preparation recommendation 358 may include seeking covered parking or shelter for the vehicle 10 during the inclement weather. Additionally or alternatively, the preparation recommendation 358 may include identification of a nearby shelter installation 606, whether at a service station 602 or at a home of the user. The preparation protocol 352 is configured to provide assistance and recommendations to the user. For example, the preparation protocol 352 may provide video instruction to the user pertaining to actions that may be taken if the private service station 602 is blocked or otherwise obstructed by the predicted weather pattern 314. Additionally or alternatively, the video instruction of the preparation protocol 352 may include instructional examples of how to utilize the accessories presented by the accessory recommendations 356. While the monitoring application 304 may execute the preparation protocol 352 in response to the predicted weather data 312, it is contemplated that the user may customize the frequency and activation of notifications associated with the preparation protocol 352. For example, the user may adjust the personal preferences 318 of the monitoring application 304 to provide intermittent notifications associated with the preparation protocol 352, which may still keep the user informed of the predicted weather pattern 314. In some examples, the user may opt to turn off notifications associated with the preparation protocol 352. Accordingly, the preparation protocol 352 is a customizable feature of the monitoring application 304.

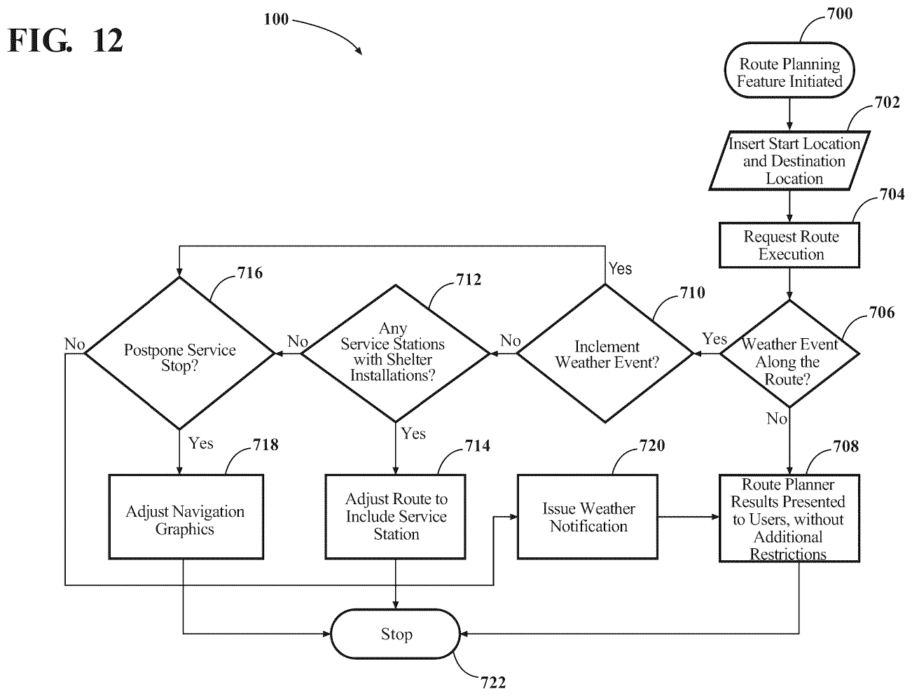

With specific reference to FIG. 12, a flow diagram illustrating the operation of the monitoring system 100 is depicted. Initially, at 700, the route planning feature 308 of the monitoring application 304 is initiated. The user may input, at 702, the start location 208 and the destination location 210, and the user, at 704, requests the navigation application 204 execute a route 206. The monitoring application 304 communicates with the weather application 310 to receive the predicted weather data 312. The monitoring application 304, at 706, identifies whether the predicted weather data 312 projects a predicted weather pattern 314 along the route 206 that is associated with inclement weather. If the predicted weather pattern 314 is not associated with inclement weather, the monitoring application 304, at 708, presents the navigation graphics 330 without the shelter icon 606a and may maintain the original route 206 free from refinement based on the predicted weather data 312.

If the predicted weather pattern 314 is associated with inclement weather, then the monitoring application 304, at 710, identifies whether the inclement weather is an extreme weather event. If the predicted weather pattern 314 is associated with inconvenient weather but is not an extreme weather event, then the monitoring application 304 communicates with the server processor 402 to identify, at 712, whether any service stations 602 along the route 206 have a shelter installation 606. If the server processor 402 identifies that the service station(s) 602 is equipped with a shelter installation 606, then the monitoring application 304, at 714, adjusts the route 206 to include the identified service station 602 and displays a shelter icon 606a on a user device 300. If the server processor 402 does not identify a service station 602 stored in the service route database 404 that is both along the route 206 and includes a shelter installation 606, then the monitoring application 304 then determines, at 716, whether the service stop 332 may be postponed until the vehicle 10 is able to reach another service station 602 or until the predicted weather pattern 314 has passed.

If the monitoring application 304 determines it is possible to postpone the service stop 332, then the monitoring application 304, at 718, may adjust the navigation graphics 330 accordingly. If the monitoring application 304 determines it is not possible to postpone and/or that the predicted weather pattern 314 is not projected to pass, then the monitoring application 304, at 720, may issue a weather notification advising the user of the predicted weather pattern 314.

In another example, if the monitoring application 304 identifies the predicated weather pattern 314 as being associated with an extreme weather pattern, then the monitoring application 304 may skip step 712 and proceed with determining whether the service stop 332 may be postponed until the vehicle 10 is able to reach another service station 602 or until the predicted weather pattern 314 has passed, at 716. Each of these operational steps 700-720 outlines the execution of the monitoring system 100 to adjust and refine a route 206 based on data obtained by the monitoring application 304 from the server processor 402, weather application 310, navigation application 204, and the vehicle processor 200. The monitoring application 304 may terminate the route planning feature 308, at 722, once the route 206 is complete. Optionally, the monitoring application 304 may update, at 722, if a new route 206 execution is requested, and in another example, the monitoring application 304 may update the route 206 if the predicted weather pattern 314 significantly changes along the route 206.

Referring again to FIGS. 1-12, the monitoring system 100 advantageously provides the user with an accessible system for organizing data ahead of travel and anticipating predicted weather patterns 314 that may impact a decision process of the user. The monitoring application 304 provides an interface for the user to customize the experience of the user. The monitoring system 100 further provides navigation graphics 330 to facilitate the ease of use with the monitoring application 304. In particular, the presentation of the shelter icon 606a with the recommended service station 602 is advantageous for the user during navigation of the route 206. Further, the monitoring system 100 may present the preparation protocol 352 to assist the user in preparing for potential inclement weather.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A monitoring system, comprising:
a vehicle processor storing battery capacity data of a battery of a vehicle and including a navigation application configured to provide a location and a route of the vehicle;
a server including a server processor communicatively coupled with the vehicle processor and storing a service route database and installation attributes of one or more service stations stored in the service route database, the server processor also including a weather application configured to predict service station weather based on predicted weather data and the service route database; and
a user device including a display and data processing hardware in communication with the display and executing a monitoring application in communication with the server processor, the server configured to receive the route of the vehicle and provide a notification on the display of the user device corresponding to one or more of the installation attributes of one or more of the service stations stored in the service route database.

2. The monitoring system of claim 1, wherein the user device includes at least one of a mobile device and an infotainment device of the vehicle.

3. The monitoring system of claim 1, wherein the monitoring application is configured to recommend a service stop based on the predicted weather data received from the server processor, the installation attributes, and the battery capacity data received from the vehicle processor.

4. The monitoring system of claim 1, wherein the server processor is configured to send a notification to the monitoring application in response to the predicted weather data, the notification including a preparation protocol.

5. The monitoring system of claim 4, wherein the preparation protocol includes at least one of a charging recommendation, accessory recommendations, and preparation recommendations.

6. The monitoring system of claim 1, wherein the server processor is configured to receive an installation update from a third party device corresponding to the installation attributes of one of the service stations stored in the service route database.

7. The monitoring system of claim 1, wherein the monitoring application is configured to display an alternate route based on the predicted weather data relative to the route of the vehicle.

8. A monitoring system for a vehicle, the monitoring system comprising:
a vehicle processor storing battery capacity data of a battery of the vehicle and including a navigation application configured to provide a location and a route of the vehicle;
a server processor communicatively coupled with the vehicle processor and storing a service route database and installation attributes of one or more service stations stored in the service route database; and
a user device including a display and data processing hardware in communication with the display and executing a monitoring application in communication with the server processor, the server processor configured to receive the route of the vehicle and provide a notification on the display of the user device corresponding to one or more of the installation attributes of the one or more service stations stored in the service route database.

9. The monitoring system of claim 8, wherein the server processor further includes a weather application communicatively coupled with the service route database and configured to provide weather data for the one or more service stations stored in the service route database.

10. The monitoring system of claim 9, wherein the installation attributes include a shelter installation proximate to a charging station of the one or more service stations.

11. The monitoring system of claim 10, wherein the monitoring application of the user device is configured to provide a route notification on the display including a reroute selection corresponding to a service station that includes the shelter installation.

12. The monitoring system of claim 11, wherein the monitoring application is configured to receive the route notification from the server processor with the server processor being configured to compare the service route database and the installation attributes with the weather data to generate the route notification.

13. The monitoring system of claim 9, wherein the monitoring application is configured to display predicted weather corresponding to a location of a service station along the route of the vehicle.

14. The monitoring system of claim 8, wherein the data processing hardware of the user device is communicatively coupled to the vehicle processor to receive the battery capacity data and configured to display the battery capacity data on the display of the user device.

15. A monitoring system, comprising:
a vehicle processor storing battery capacity data of a battery of a vehicle and including a navigation application configured to provide a location of the vehicle and a vehicle route; and
a user device including a display and data processing hardware in communication with the display and executing a monitoring application in communication with the vehicle processor and executing a weather application including predicted weather data, the data processing hardware being configured to receive the vehicle route and provide a notification on the display of the user device corresponding to an installation attribute of a service station along the vehicle route.

16. The monitoring system of claim 15, further including a server that includes a server processor communicatively coupled with the vehicle processor and storing a service route database and installation attributes of one or more service stations stored in the service route database.

17. The monitoring system of claim 16, wherein the service route database includes an availability status of a charging station at one of the service stations.

18. The monitoring system of claim 17, wherein the server processor is configured to identify a service station from the service route database that includes an installation attribute and is configured to determine whether there is sufficient battery capacity of the vehicle to reroute the vehicle route based on the battery capacity data and the predicted weather data.

19. The monitoring system of claim 17, wherein the vehicle processor is configured to execute the vehicle route in response to a user input to the navigation application and based on the installation attributes stored in the service route database.

20. The monitoring system of claim 17, wherein the monitoring application is configured to issue a route notification corresponding to an updated route based on the predicted weather data and the vehicle route.
